(19) United States
(12) Patent Application Publication
(10) Pub. No.: US 2012/0086890 A1
(43) Pub. Date: Apr. 12, 2012

(54) BACKLIGHT DEVICE AND LIQUID CRYSTAL DISPLAY DEVICE

(75) Inventors: Hiroyuki SHIMOKAWA, Mobara (JP); Masamitsu MIYATA, Mobara (JP)

(73) Assignee: Hitachi Displays, Ltd.

(21) Appl. No.: 13/253,178

(22) Filed: Oct. 5, 2011

(30) Foreign Application Priority Data
Oct. 7, 2010 (JP) 2010-227330

(51) Int. Cl. G02F 1/13357; G09F 13/04

(52) U.S. Cl. 349/65; 362/606

(57) ABSTRACT

A mold frame used for a backlight device is thinned to enable a frame of a liquid crystal display device to be narrowed. Gates for injection molding are arranged on an inner side surface of a mold frame. The inner side surface forms recesses in portions including the positions of the gates. Protrusions for preventing optical sheets from dropping out are disposed on an edge of the optical sheets housed within the mold frame in correspondence with the recesses accompanied by the injection molding. The recesses are used for engaging the protrusions, thereby requiring no provision of additional recesses for engaging the protrusions.

### CROSS-REFERENCE TO RELATED APPLICATION

The present application claims priority from Japanese application JP 2010-227330 filed on Oct. 7, 2010, the content of which is hereby incorporated by reference into this application.

### BACKGROUND OF THE INVENTION

1. Field of the Invention

The present invention relates to a backlight device, and a liquid crystal display device using the backlight device.

2. Description of the Related Art

The liquid crystal display device includes a liquid crystal panel whose transmittance of liquid crystal is controlled on the pixel basis, and a backlight device that is disposed on a back surface of the liquid crystal panel, and irradiates the liquid crystal panel with an illumination light. In a downsized liquid crystal display device used for cellular phones, the backlight device is of a structure in which a light from a light source arranged on one side of a screen is planarly diffused by a light guide plate, and this structure enables the shape of the backlight device to be thinned. In this configuration, a reflection sheet is disposed on a back surface of the light guide plate, and an optical sheet group including a diffusion sheet and a prism sheet is disposed between a front surface of the light guide plate and the liquid crystal panel. Those members are assembled integrally with the use of a mold frame. The mold frame is a frame formed by injection molding a resin. The reflection sheet is attached to a back surface of the mold frame, and the light guide plate and the optical sheet are housed within a frame of the mold frame.

FIG. 8 is a schematic diagram illustrating a prior art injection molding of the mold frame. FIG. 8 illustrates a mold frame 2 and a runner part 4. A mold not shown is formed with a cavity having the shape of the mold frame 2. The cavity is connected to the runner through a plurality of gates disposed at a position where molten resin uniformly enters the entire cavity. Up to now, the gates are arranged on the back surface or front surface of the mold frame 2 to conduct injection molding.

When the resin that has been injected into the cavity and the runner has been cooled and solidified, an intermediate molded product 8 in which the mold frame 2 and the runner part 4 are integrated together is extracted from the mold as illustrated on an upper side of FIG. 8. The intermediate molded product 8 is cut off at the positions of the gates (gate parts 6), and the mold frame 2 is separated from the runner part 4 as illustrated on a lower side of FIG. 8.

The tips of the gate parts 6 remain on the mold frame 2 side depending on a precision of cutting, and projections may be generated on the surface of the mold frame 2. Therefore, the surface of the mold frame 2 in the vicinity of each gate is retreated and a recess is formed in the surface thereof in advance so that each projection does not pose a problem for the attachment of another member to the surface thereof. Even if the projection occurs due the residual gate, the projection is not protruded from the recess. The opening of the recess needs, for example, the dimension of about 1 mm according to the size of the tip of a jig used for cutting off the gates.

### SUMMARY OF THE INVENTION

With the narrowed frame of the liquid crystal display device, there is a demand to reduce the thickness of a mold frame, and the diameter of the frame (frame width). In recent years, for example, those thickness and diameter can be reduced to lower than 1 mm. Where the gates are arranged on the circumstance of the mold frame is determined from the viewpoint that the molten resin flows into a cavity simultaneously and uniformly. From this viewpoint, there may be a demand to arrange the gates on thin portions of the mold frame in which the thickness or the width of the mold frame is fine. However, it is not easy to ensure an arrangement space of the gates accompanied by the above-mentioned recesses on such thin portions. Also, since the backlight device has a thin shape, the strength of the backlight device in the thickness direction is basically lower than that in other directions. For that reason, when each position of the gates is set on a front surface or a back surface of the thin portion of the mold frame, the thickness of the mold frame is reduced in each of the above recesses, resulting in such a problem that the strength of the backlight device in the thickness direction is further weakened. Further, a recess for receiving a protrusion provided on an edge of the optical sheet is provided in an inner side surface of the frame aside from the recesses in the vicinity of the gates, and this recess further reduces the strength.

The present invention has been made to solve the above problem, and therefore aims at providing a backlight device and a liquid crystal display device which enable the miniaturization of the mold frame to further thin the frame.

According to the present invention, there is provided a backlight device including a light guide plate having a reflection sheet arranged on a back surface thereof; at least one optical sheet which is disposed on a light emitting surface of the light guide plate, and formed of a diffusion sheet or a prism sheet; and a mold frame that houses a laminated body including the light guide plate and the optical sheet inside, and is molded by injecting a resin from a gate arranged on an inner side surface of the frame. The mold frame has a recess having a bottom surface formed by retreating the inner side surface at a portion including a position of the gate, in which the expanse of the bottom surface in the thickness direction of the mold frame reaches at least a front surface thereof, and the at least one optical sheet has a protrusion fitted into the recess.

One preferable mode of the present invention is a backlight device in which the expanse of the recess in the thickness direction reaches only the front surface of the mold frame, and is not continuous to the back surface thereof.

Another preferable mode of the present invention is a backlight device in which the recess is linearly narrowed toward a retreat direction of the inner side surface, and trapezoidal when viewed from the front side.

According to the present invention, there is provided a liquid crystal display device including the backlight device according to the present invention; and a liquid crystal display panel equipped on a front surface of the backlight device.

### BRIEF DESCRIPTION OF THE DRAWINGS

FIG. 1 is an exploded perspective view of an outline of a backlight device according to an embodiment of the present invention;

FIG. 2 is a schematic cross-sectional view illustrating apart of a vertical section of a liquid crystal display device according to the embodiment of the present invention;

FIG. 3 is a schematic view illustrating injection molding of a mold frame in the backlight device according to the embodiment;

FIG. 4 is a schematic plan view of the mold frame within which an optical sheet is arranged;

FIG. 5 is a schematic perspective view of a portion of the mold frame in which a recess is formed;

FIG. 6 is a schematic perspective view illustrating another example of the recess formed in the mold frame;

FIG. 7 is a schematic plan view illustrating still another example of the recess formed in the mold frame; and

FIG. 8 is a schematic view illustrating prior art injection molding of the mold frame.

### DESCRIPTION OF THE PREFERRED EMBODIMENTS

Hereinafter, embodiments of the present invention will be described with reference to the accompanying drawings.

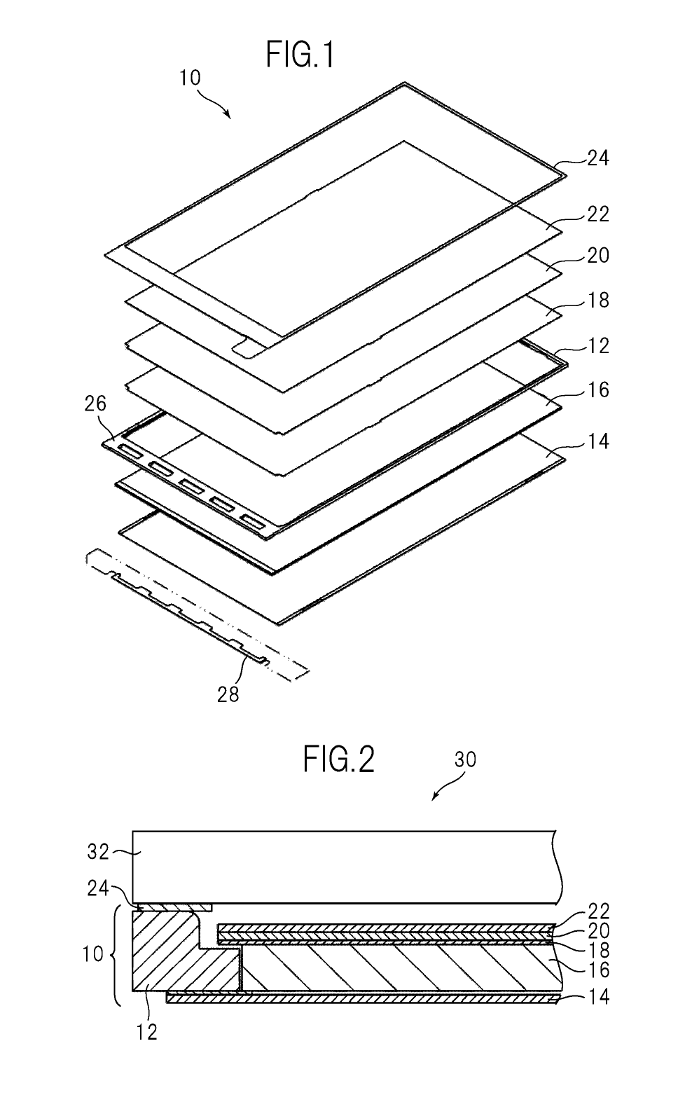

FIG. 1 is an exploded perspective view of an outline of a backlight device 10 according to an embodiment. The backlight device 10 is of a sidelight type, and a reflection sheet 14 is attached to a back surface of a mold frame 12 having a rectangular frame shape. A light guide plate 16, a diffusion sheet 18, and prism sheets 20 and 22 are laminated in the stated order within a frame of the mold frame 12 to which the reflection sheet 14 is attached. A light blocking tape 24 is attached to a front surface of the mold frame 12 along a frame circumstance. Also, one of short sides of the mold frame 12 is widened, and a fixation tape 28 is attached to a back surface of a wider portion 26.

An electronic substrate (not shown) having light emitting diodes (LEDs) arrayed is attached to the back surface of the wider portion 26 of the mold frame 12. The fixation tape 28 fixes the electronic substrate to the mold frame 12.

The LEDs are a light source for the backlight device 10 of the sidelight type. The light guide plate 16 is made of acrylic, and receives an LED light from a lateral part of the wider portion 26 side. The incident light is planarly diffused while total reflection is repeated within the light guide plate 16. The light guide plate 16 has a surface (light emitting surface) of the front surface side uniformly lighted with the light transmitted at various parts thereof.

The reflection sheet 14 is equipped with an adhesion member such as an adhesive tape on an edge of the reflection sheet 14 in advance, and fixed to the mold frame 12 with the adhesion member. The reflection sheet 14 reflects a light leaked from the back surface of the light guide plate 16 so as to return the light to the light guide plate 16, thus improving the light emission efficiency of the backlight device 10.

The diffusion sheet 18 is a film coated with a resin that allows light diffusion. The diffusion sheet 18 diffuses the light output from the surface of the light guide plate 16, and improves the uniformity of the light intensity within the light emitting surface.

Each of the prism sheets 20 and 22 is a film having a surface formed with a streaky prism or lens extending in one direction, and condenses the light, which is output from the diffusion sheet 18 in various directions of the front surface, mainly in a direction perpendicular to that surface to improve the luminance on a front surface of the light emitting surface. Each of the prism sheets 20 and 22 condenses the light in a direction orthogonal to an extending direction of the prism or the like. Those two prism sheets 20 and 22 different in the condensing direction are stacked on each other to realize two-dimensional condensing.

FIG. 2 is a schematic cross-sectional view illustrating a part of a vertical section of a liquid crystal display device 30 according to the embodiment. The liquid crystal display device 30 has a liquid crystal display panel 32 arranged on the front surface of the backlight device 10. A light blocking tape 24 is an adhesion member that allows the backlight device 10 to adhere to the liquid crystal display panel 32 in the liquid crystal display device 30. The adhesion member has a light blocking property so as not to pose a problem that the light of the backlight device 10 is leaked from the adhesion portion to deteriorate the contrast of the liquid crystal display device 30.

The liquid crystal display panel 32 includes a pair of transparent glass substrates, liquid crystal held therebetween, and other components, but those structures are omitted from FIG. 2. In the liquid crystal display panel 32, the orientation of liquid crystal is controlled on the pixel basis to change the transmittance of the light input from the backlight device 10, thereby forming an image on a screen.

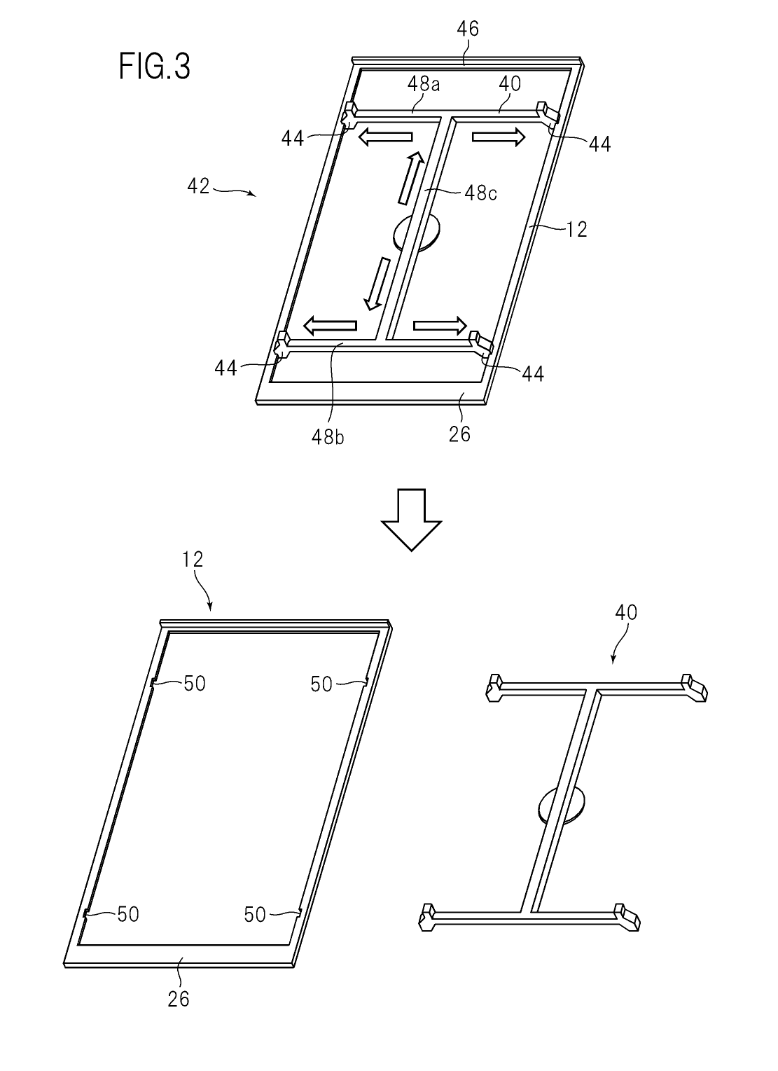

As described above, the mold frame 12 is formed into the rectangular frame shape, and houses the laminated body of the light guide plate 16 and the optical sheet (diffusion sheet 18 and prism sheets 20 and 22) within the frame. The mold frame 12 is formed by injection molding a resin by the aid of a mold. FIG. 3 is a schematic view illustrating injection molding of the mold frame 12. The mold is formed with a cavity corresponding to the mold frame 12, and the cavity is connected to a runner made of a resin at injection ports (gates). The molten resin is injected into the cavity through the runner and the gates, the resin is cooled and solidified, and the mold is then removed. An upper side of FIG. 3 illustrates a state in which the mold is removed, and an intermediate molded product 42 is obtained in which the mold frame 12 formed by the cavity, and a runner part 40 having the runner into which the resin has been injected are integrated together.

In the intermediate molded product 42, gate parts 44 correspond to the position of the gates. The gates are located at positions where the molten resin uniformly enters the entire cavity. In order to realize uniform injection, the gates can be located at a plurality of places. In this embodiment, four of the gates are provided, and two gates are arranged on each of long sides because a larger amount of resin is required for the long sides than short sides in the mold frame 12 of the rectangular frame shape. Also, because the wider portion 26 needs a larger amount of resin injection than the other thin short side 46 in the two short sides, a distance between the wider portion 26 and the nearest gates is set to be shorter than a distance between the thin short side 46 and the nearest gates.

Different from the configuration described in the prior art, those gates are arranged on the inner side surface of the mold frame 12. For example, the runner includes portions 48a and 48b that each extend in parallel to the short sides of the mold frame 12, and have both ends connected to two gates facing each other on the two long sides, and a portion 48c that has both ends connected to center portions of those portions 48a and 48b, and extends in parallel to the long sides so as to be H-shaped. The molten resin is injected from the center of the portion 48c, flows from portion 48c into the portions 48a and 48b, and is further injected into the cavity through the gates.

The intermediate molded product 42 is cut off at the gate parts 44 whereby as illustrated on a lower side of FIG. 3, the mold frame 12 is separated from the runner part 40. The mold frame 12 includes recesses 50 each formed by retreating the inner side surface at a portion including the position of each gate. As in the prior art, the recesses 50 are provided as a measure against projections that may be generated as gate trails on the mold frame 12.

The recesses 50 are opened on at least the front surface side in the thickness direction of the mold frame 12. That is, no wall is formed between the recesses 50 and the front surface (upper surface) of the mold frame 12 along the thickness direction of the mold frame 12, and the retreated inner side surfaces forming the bottom surfaces of the recesses 50 reach the upper surface of the mold frame 12. Hence, the recesses 50 appear in the upper surface of the mold frame 12.

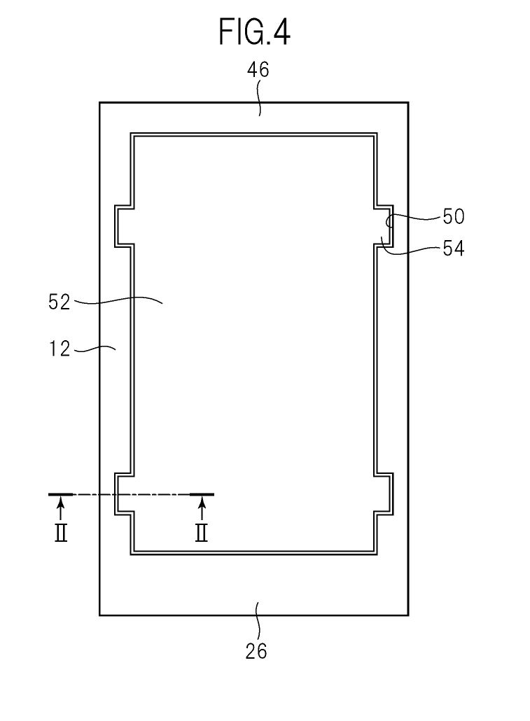

FIG. 4 is a schematic plan view of the mold frame 12 within which optical sheets 52 are arranged. FIG. 4 illustrates the recesses 50 appearing in the upper surface of the mold frame 12 in an easy-to-understand manner. As illustrated in FIG. 4, the optical sheets 52 (diffusion sheet 18, and prism sheets 20, 22) arranged within the mold frame 12 has protrusions 54 fitted into the respective recesses 50. Since the recesses 50 are opened on the front surface side, if the optical sheets 52 are placed within the mold frame 12, the protrusions 54 enter the recesses 50.

In the backlight device 10, the optical sheets 52 are basically merely placed within the mold frame 12, and not fixed by a unit such as adhesion. For that reason, in the backlight device 10, in a state where the liquid crystal display panel 32 is not attached to the front surface of the backlight device 10, there is a possibility that the optical sheets 52 come out of the mold frame 12, and drop out due to vibration during transportation. As compared with a case in which no protrusions 54 are provided, the protrusions 54 entering the recesses 50 make it difficult that the optical sheets 52 drop out. Also, the prism sheets 20 and 22 may be so warped as to float the ends thereof. However, the provision of the protrusions 54 can make it difficult for the ends to float from the mold frame 12. A fine gap may be provided between the mold frame 12 and the optical sheets 52 taking a difference in heat contraction among the respective members, and processing accuracy into account.

The protrusions 54 may be disposed at the positions of the respective recesses 50 as illustrated in FIG. 4, or maybe disposed at only the positions of the partial recesses 50. For example, when the warpages of the prism sheets 20 and 22 occur in a specific diagonal direction, the protrusions 54 can be disposed at only the positions of the recesses 50 close to two corners on the diagonal line.

Also, the protrusions 54 may be provided on all of the optical sheets 52, or a partial optical sheet 52. For example, the protrusions 54 are disposed on only a prism sheet 22 positioned at the top of the optical sheets 52, thereby enabling the diffusion sheet 18 and the prism sheets 20 and 22 disposed therebelow to be prevented from dropping out.

The recesses 50 are formed with the above-mentioned injection molding, and the positions of the recesses 50 are designed so that the molten resin is appropriately injected. In the backlight device 10, the recesses 50 are utilized to accept the protrusions 54. With the above configuration, there is no need to additionally form recesses for fitting the protrusions 54 in the mold frame 12. That is, while a reduction in the strength of the backlight device 10 attributable to a fact that the mold frame 12 is thinned by the recesses is reduced, the protrusions 54 are provided so that the optical sheets 52 can be prevented from dropping out.

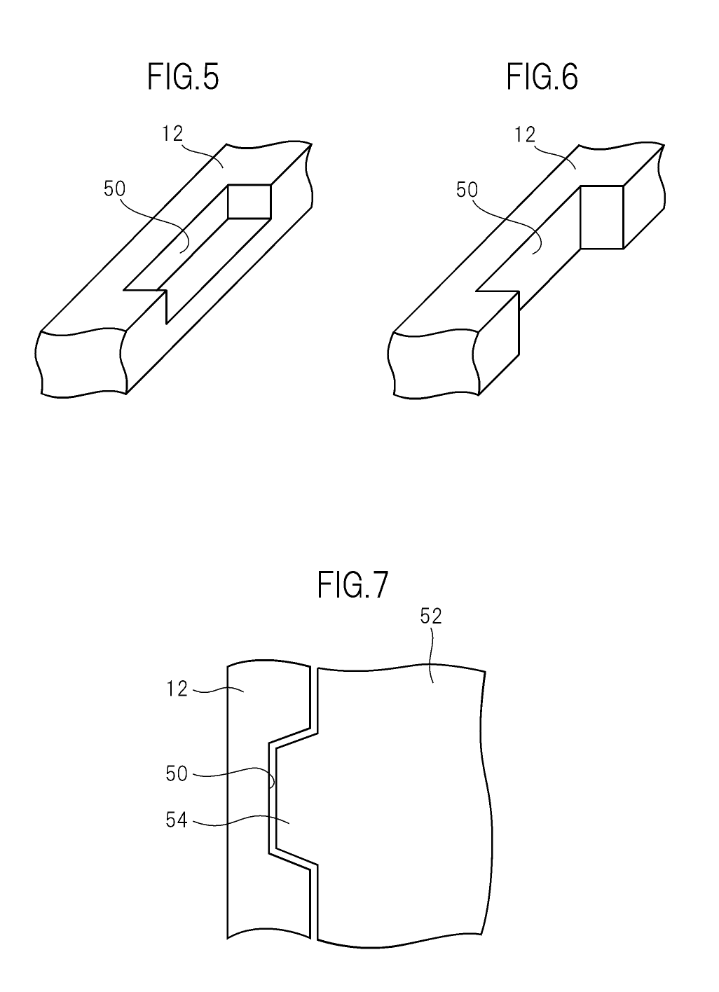

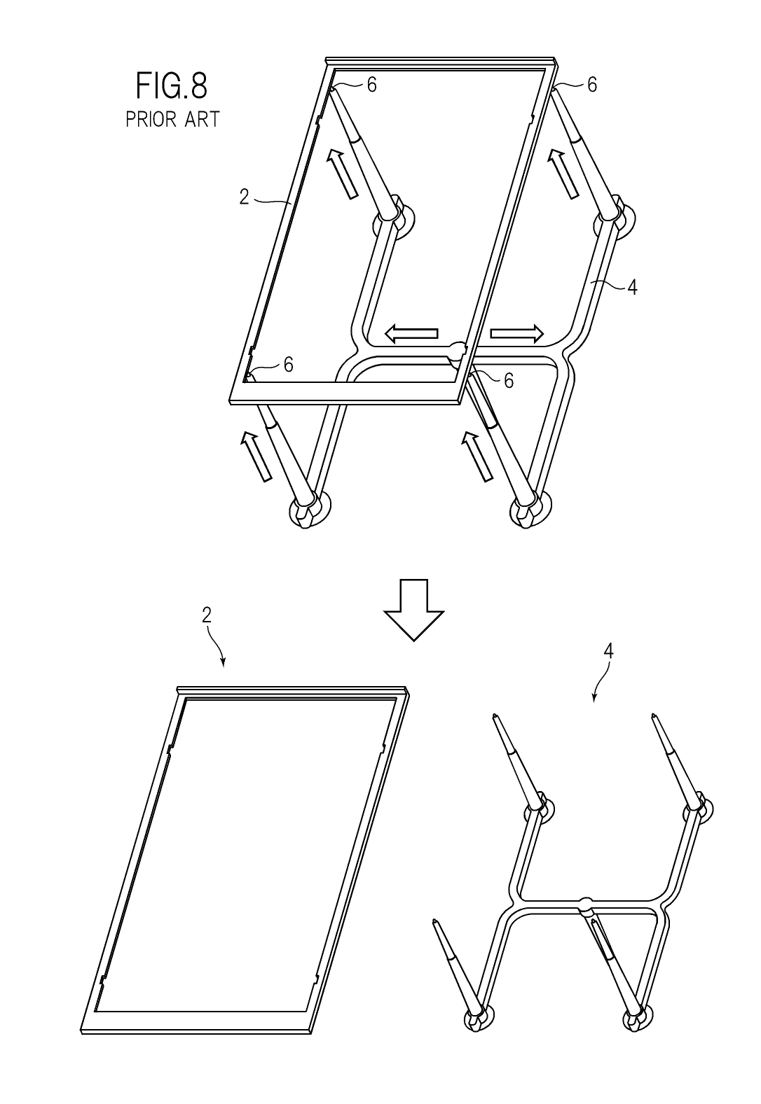

FIG. 5 is a schematic perspective view of a portion of the mold frame 12 in which the recess 50 is formed. The recess 50 illustrated in FIG. 5 is opened on only the front surface side in the thickness direction of the mold frame 12, but is not continuous to the back surface side. A cross section of the mold frame 12 in each of the recesses 50 is illustrated in FIG. 2, and as illustrated in the figure, the recess 50 is shaped so that a corner of the inner front surface of the mold frame 12 is notched in an L-shape. The cross section of the backlight device 10 in FIG. 2 corresponds to, for example, a position of a line II-II in FIG. 4.

Apart of the mold frame 12 in the thickness direction is not recessed in the recess 50, but remain as the original width is, with the result that the reduction in the strength of the mold frame 12 can be reduced.

FIG. 6 is a schematic perspective view illustrating another example of a portion of the mold frame 12 in which each of the recesses 50 is formed. The recess 50 illustrated in FIG. 6 is also opened on the back surface side in the thickness direction of the mold frame 12. That is, the bottom surface of the recesses 50 is continuous from the front surface to the back surface of the mold frame 12. This recess 50 is lower in the strength of the mold frame 12 in the width direction than the recess 50 in FIG. 5. However, as compared with a case in which the provision of the recess having the same size in the front surface or the back surface of the mold frame 12 further reduces the strength in the thickness direction which is weaker than that in the short side direction or the long side direction of the backlight device 10, an influence of the recess 50 in FIG. 6 on the strength of the backlight device 10 is small.

The recesses 50 exemplified by the figures are rectangular when viewed from the front surface. That is, the bottom surface of the recesses 50 and the respective inner side surfaces of the mold frame 12 at both sides of the recesses 50 are perpendicular to each other. The frontage dimension and the bottom surface dimension of the recesses 50 in the long side direction of the mold frame 12 are basically identical with each other. However, the frontage dimension and the bottom surface dimension may be different from each other.

FIG. 7 is a schematic plan view illustrating another example of a portion of the mold frame 12 in which each of the recesses 50 is formed. The recess 50 illustrated in FIG. 7 has a linear taper that is narrowed toward the retreat direction of the inner side surface, and is trapezoidal when viewed from the front surface. That is, the recess 50 is formed so that the bottom surface dimension is smaller than the frontage dimension. This forward tapered recess 50 can be easily formed in the injection molding. The protrusions 54 of the optical sheets 52 can be so tapered as to fit into the recesses 50. In the shape of the optical sheets 52, a bend portion (an internal angle of two walls) of a base of each protrusion 54 becomes obtuse, thereby making it difficult that the optical sheets 52 are split inward from that portion. In order to suppress the occurrence of the split, that portion may be more smoothly shaped such as a circular arc.

When the gates are disposed on the inner side surface of the mold frame 12, the recesses 50 do not appear on the exterior surface of the backlight device 10. This not only causes no disfigurement of the backlight device 10, but also can use the outer side surface of the mold frame 12 as an adhesion space when the backlight device 10 or the liquid crystal display device 30 using the backlight device 10 is incorporated into another device, or can ensure the degree of freedom of design when a structure for assembling is formed on the outer side surface of the mold frame 12, separately. Also, in addition to the arrangement of the gates on the inner side surface of the mold frame 12, the runner is connected to the gates from the lateral part, and the recesses 50 provided in correspondence with the gates are opened on the front surface side. With this configuration, when the intermediate molded product 42 is split as illustrated in FIG. 3, a blade edge of a jig used for cutting off the gates can be linearly inserted from the front surface side so as to be abutted against the base (end of the mold frame 12 side) of each gate. The direction of inserting the blade edge from the front surface toward the back surface is common in the respective recesses 50, and cutting off on the respective recesses 50 can be easily conduced at the same time.

For reference, as parts of the downsized device such as cellular phones, the backlight device 10 and the liquid crystal display device 30 according to the present invention can be used. In such a downsized device, the thickness or width of the mold frame 12 can be set to about 1 mm or lower. In the mold frame 12 having the thin width, the depth of the recesses 50 is naturally shallower than the frame width. From the viewpoint of ensuring the strength, it is preferable that the recesses 50 can be made as shallow as possible. The frontage dimension (or bottom surface dimension) of the recesses 50 needs to have a size that allows the blade edge of the cutting jig to be inserted into the recesses 50. However, it is preferable from the viewpoint of strength that the blade edge of the jig is made fine, and the frontage dimension is made as small as possible. For example, the frontage dimension can be set to about 1 mm.

According to the present invention, the mold frame can be further miniaturized, thereby realizing the backlight device and the liquid crystal display device in which the frame is further narrowed.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A backlight device disposed on a back surface of a liquid crystal display panel, the backlight device comprising:
a light guide plate having a reflection sheet arranged on a back surface thereof;
at least one optical sheet which is disposed on a light emitting surface of the light guide plate, and formed of a diffusion sheet or a prism sheet; and
a mold frame that houses a laminated body including the light guide plate and the optical sheet inside, and is molded by injecting a resin from a gate arranged on an inner side surface of the frame,
wherein the mold frame has a recess having a bottom surface formed by retreating the inner side surface at a portion including a position of the gate, in which the expanse of the bottom surface in the thickness direction of the mold frame reaches at least a front surface thereof, and
wherein the at least one optical sheet has a protrusion fitted into the recess.

2. The backlight device according to claim 1,
wherein the expanse of the recess in the thickness direction reaches only the front surface of the mold frame, and is not continuous to the back surface thereof.

3. The backlight device according to claim 1,
wherein the recess is linearly narrowed toward a retreat direction of the inner side surface, and trapezoidal when viewed from the front side.

4. A liquid crystal display device, comprising:
a backlight device according to claim 1; and
a liquid crystal display panel equipped on a front surface of the backlight device.
